(19) United States
(12) Patent Application Publication
(10) Pub. No.: US 2025/0068140 A1
(43) Pub. Date: Feb. 27, 2025

(54) DIAGNOSTIC DEVICE

(71) Applicant: OKUMA CORPORATION, Niwa-Gun (JP)

(72) Inventor: Reiji KANBE, Niwa-Gun (JP)

(73) Assignee: OKUMA CORPORATION, Niwa-Gun (JP)

(21) Appl. No.: 18/804,208

(22) Filed: Aug. 14, 2024

(30) Foreign Application Priority Data
Aug. 24, 2023 (JP) 2023-136549

(51) Int. Cl. G05B 19/406

(52) U.S. Cl. CPC G05B 19/406; G05B 2219/37438

(57) ABSTRACT

A diagnostic device includes an error transition recording unit, an error transition input unit, an error cause recording unit, a cause diagnosis unit, and a display portion. A plurality of types of error transition information with different temporal transitions of the machining error caused by repeating the machining are recorded in the error transition recording unit. The error transition input unit selects one or a plurality of pieces of error transition information from the plurality of types of error transition information. A plurality of types of the causes are each recorded in association with the error transition information in the error cause recording unit. The cause diagnosis unit refers to the error cause recording unit and identifies the causes based on the error transition information selected by the error transition input unit. The display portion displays the causes identified by the cause diagnosis unit.

### CROSS REFERENCE TO RELATED APPLICATION

This application claims the benefit of Japanese Patent Application Number 2023-136549 filed on Aug. 24, 2023, the entirety of which is incorporated by reference.

### FIELD OF THE INVENTION

The disclosure relates to a diagnostic device for diagnosing a cause of a machining error in a workpiece machined with a machine tool, for example, an NC device.

### BACKGROUND OF THE INVENTION

In checking dimensions and shapes of a workpiece machined with a machine tool by a measuring instrument, when a machining error is large, it is necessary to investigate its causes and take countermeasures. As the causes of the machining error, a plurality of causes are conceivable, such as an accuracy failure of the machine tool, thermal displacement, tool abrasion, a measurement error of a machining origin point, the measurement error of a tool-offset compensation value. Therefore, as a general investigation, first, an operator of the machine tool confirms, for example, the machining origin point, the measurement error of the tool-offset compensation value, the tool abrasion. Then, when there are no problems with them, a maker will execute accuracy inspections of the machine tool, such as inspecting a positioning accuracy of the machine by using a laser measuring device and measuring an inversion protrusion with a double ball bar device. Accordingly, it often takes time to perform the cause investigation of the machining errors.

Thus, in order to be able to diagnose the causes of the machining errors in a short period of time, JP 2019-206056 A discloses a diagnostic device where the causes of the machining errors are categorized into a plurality of categories. The plurality of categories is, for example, a tool factor including tool abrasion, a mechanical factor including the accuracy failure of the machine tool, and a jig factor including a fixation failure of the workpiece. In addition, feature quantities of the machine data and measurement data of the workpiece are extracted and stored for each factor. Then, when detected quantities of the machine data and the measurement data of the workpiece detected during machining is close to the preliminarily stored feature quantities, it is determined that the factor associated with the feature quantity is the causes of the machining error. Thus, it becomes possible to perform the cause diagnosis of the machining errors in a short period of time.

JP 6001211 B discloses a diagnostic device where a thermal displacement amount by an internal heat source of the machine tool and a thermal displacement amount by an environment temperature change are each determined. In addition, a tool-offset compensation value, temperature, and a temporal transition of thermal displacement compensation amount related to each thermal displacement amount are displayed in graph. Then, by confirming the graphical display, an operator can easily understand whether or not the actually occurring thermal displacement and tool abrasion match the experiential feeling of the operator.

However, in the diagnostic devices disclosed in JP 2019-206056 A and JP 6001211 B, since it is necessary to collect at least machine data during machining, the entire device becomes large-scale, and it can be said that there is a problem in terms of cost. In particular, although the diagnostic device disclosed in JP 6001211 B displays information related to current machining, sufficient experience is required to diagnose causes of machining errors from the display. Thus, there is also a problem that it is difficult for less experienced operator to perform cause diagnosis.

Therefore, the disclosure is made in view of the above-described problems. It is an object of the disclosure to provide a diagnostic device that eliminates a need to collect machine data during machining that can cause machining errors and allow even a less experienced operator to easily and reliably diagnose the cause of the machining errors.

### SUMMARY OF THE INVENTION

To achieve the above-described object, a first aspect of the disclosure is a diagnostic device for diagnosing a cause of a machining error that occurs at each machining operation on a plurality of workpieces having a same shape includes an error transition recording unit, an error transition input unit, an error cause recording unit, a cause diagnosis unit, and a display portion. A plurality of types of error transition information with different temporal transitions of the machining error caused by repeating the machining are recorded in the error transition recording unit. The error transition input unit selects at least one of pieces of error transition information from the plurality of types of error transition information. A plurality of types of the causes are each recorded in association with the error transition information in the error cause recording unit. The cause diagnosis unit refers to the error cause recording unit and identifies the causes based on the error transition information selected by the error transition input unit. The display portion displays the causes identified by the cause diagnosis unit.

In a second aspect of the disclosure, which is in the first aspect of the disclosure, a machined portion input unit used for inputting machined portion information that is information related to identifying the machining error in the workpiece; and cutting condition input unit used for inputting cutting condition information that is information related to machining to the workpiece. The cause is also associated with the machined portion information and the cutting condition information. The cause diagnosis unit refers to the error cause recording unit and identifies the cause based on the error transition information selected by the error transition input unit, the machined portion information input by the machined portion input unit, and the cutting condition information input by the cutting condition input unit.

In a third aspect of the disclosure, which is in the second aspect of the disclosure, the diagnostic device is connected to an NC device, and at least any one piece of the machined portion information and the cutting condition information can be selected and input from data recorded in the NC device.

In a fourth aspect of the disclosure, which is in any one of the first to third aspects of the disclosure, an actually measured value of the temporal transition of the machining error can be input by the error transition input unit. Based on the input actually measured value of the temporal transition, the error transition input unit calculates at least one of an initial product machining error Δa which is the machining error from a target value in a first machined workpiece, an absolute value Δb of a displacement width of the machining error that has occurred between the first machined workpiece and a finally machined workpiece, a maximum value Δc of a difference between the machining error in previous machining and the machining error in current machining, an error Δd with a linear approximation value, and an error Δe with a first-order lag equation approximation value, which are feature quantities related to selection of the error transition information, and selects the error transition information based on the calculated feature quantities.

In a fifth aspect of the disclosure, which is in the fourth aspect of the disclosure, the error transition information is categorized into at least one of a first to sixth error transition. The first error transition is a case in which the initial product machining error Δa exceeds a predetermined determination value J1. The second error transition is a case in which the initial product machining error Δa is smaller than the determination value J1 and the absolute value Δb of the displacement width ΔY is smaller than a determination value J2. The third error transition is a case in which the absolute value Δb of the displacement width ΔY exceeds a predetermined determination value J2 and the maximum value Δc of the difference between the previous and current machining errors also exceeds a predetermined determination value J3. The fourth error transition is a case in which the absolute value Δb of the displacement width ΔY exceeds the determination value J2, but the error Δd with the linear approximation value is smaller than a predetermined determination value J4. The fifth error transition is a case in which the absolute value Δb of the displacement width ΔY exceeds the determination value J2, but the error Δe with the first-order lag equation approximation value is smaller than a predetermined determination value J5. The sixth error transition is a case in which the absolute value Δb of the displacement width ΔY exceeds the determination value J2, the error Δd with the linear approximation value is larger than predetermined determination value J4 and the error Δe with the first-order lag equation approximation value is larger than predetermined determination value J5. The cause diagnosis unit identifies the causes based on the error transition information categorized into the first to sixth error transition or a combination thereof.

The temporal transition of the machining errors caused by repeating the machining in the disclosure is not limited to one in which the machining errors caused by each machining operation are associated with machining time. The temporal transition includes one in which the machining errors caused by each machining operation are associated with a count of times of machining and one in which the machining errors caused by each machining operation are associated with a count of pieces of machining. In addition to errors occurring in the workpiece, the machining errors in the disclosure according to the first aspect includes, for example, an error in a tool length offset measured by a tool sensor and an error in a machining origin point of the workpiece measured by a probe or the like.

According to the disclosure, the diagnosis device includes the error transition recording unit, the error transition input unit, the error cause recording unit, the cause diagnosis unit, and the display. The error transition recording unit is configured such that a plurality of types of pieces of error transition information with different temporal transitions of machining errors caused by repeating the machining are recorded. The error transition input unit selects one or a plurality of pieces of error transition information from the plurality of types of pieces of error transition information. The error cause recording unit is configured such that a plurality of types of causes are each recorded in association with the error transition information. The cause diagnosis unit refers to the error cause recording unit and identifies the cause based on the error transition information selected by the error transition input unit. The display par displays the cause identified by the cause diagnosis unit. Thus, by simply selecting the error transition information similar to the current machining circumstances, an operator can grasp the causes of the machining errors. Accordingly, even a less experienced operator can easily and reliably diagnose the causes of the machining errors. Since there is no need to collect the machine data that is likely to become factors of the machining errors during machining, it is possible to achieve reduced cost of the diagnostic device.

### BRIEF DESCRIPTION OF THE DRAWINGS

FIG. 1 is a block diagram illustrating a configuration of a diagnostic device.

FIG. 2 is an explanatory view illustrating a shape diagram of a workpiece.

FIGS. 3A to 3F are explanatory views illustrating temporal transitions of a plurality of types of machining errors recorded in an error transition recording unit.

FIG. 4 is an explanatory view illustrating an aspect of display in a display portion of the diagnostic device.

FIG. 5 is an explanatory view illustrating a modification example of the aspect of display in the display portion.

FIG. 6 is an explanatory view illustrating a machining method of the workpiece.

FIG. 7 is a table in which causes of machining errors are associated with machined portions, a type of tool, and displacement data.

FIG. 8 is an explanatory view illustrating the temporal transition of the machining errors obtained in actual machining.

### DETAILED DESCRIPTION OF THE INVENTION

The following describes a diagnostic device according to an embodiment of the disclosure in detail based on the drawings.

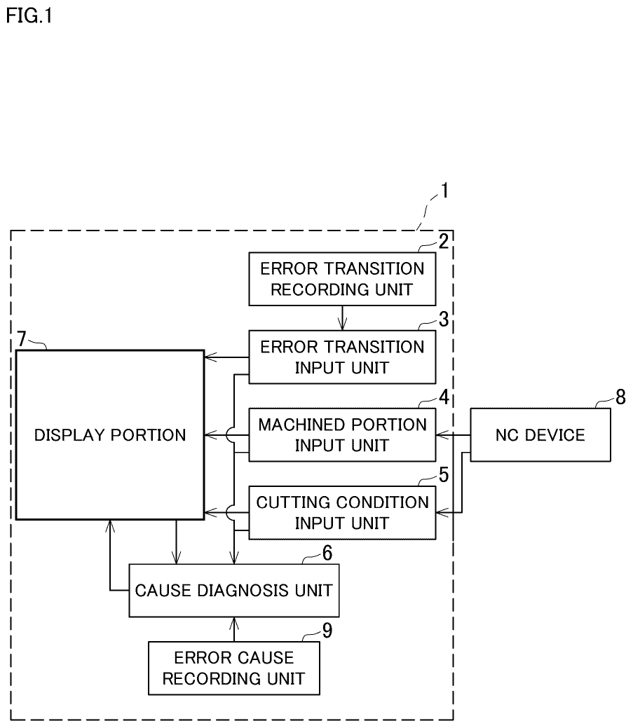

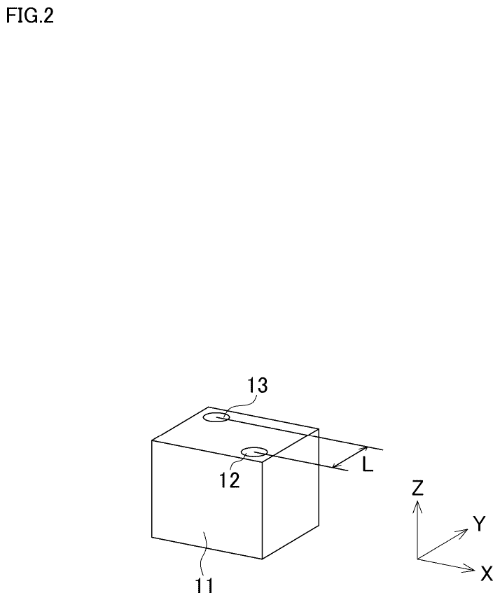

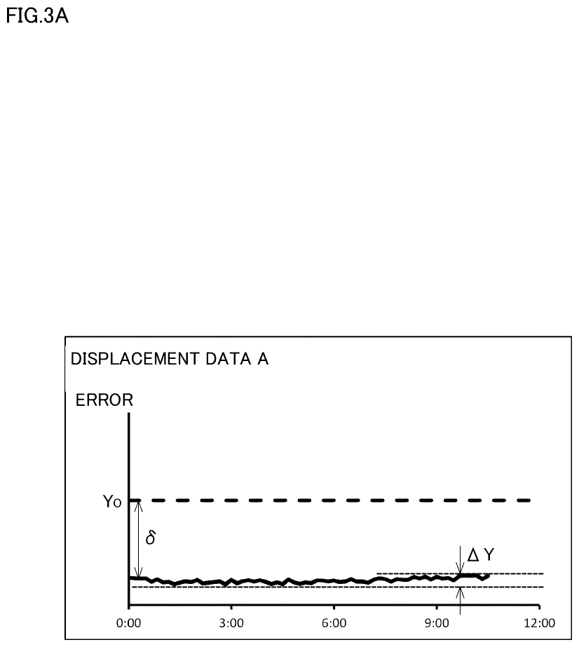

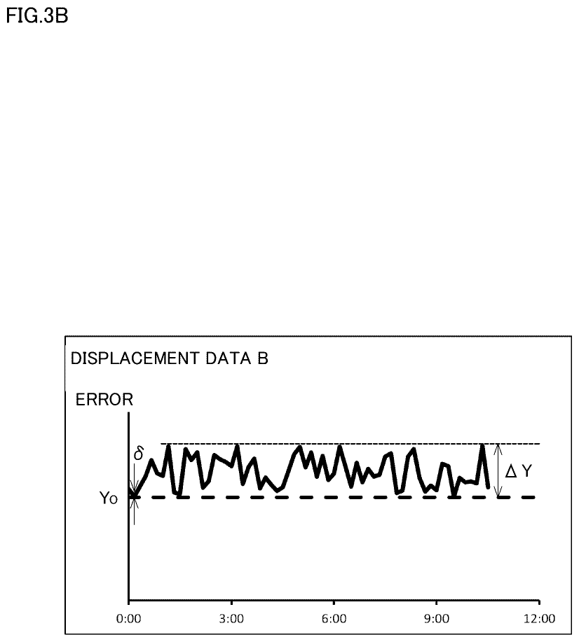

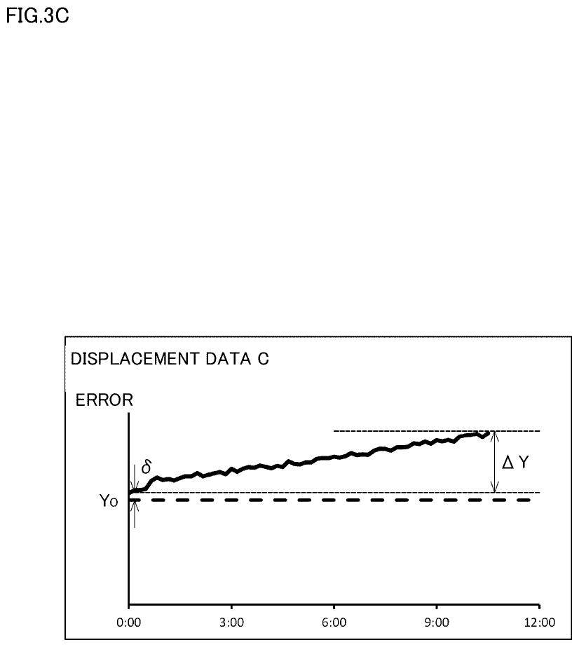

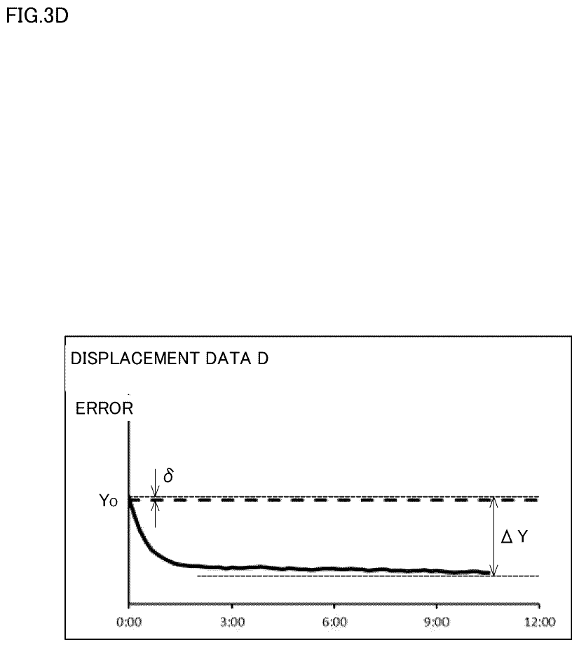

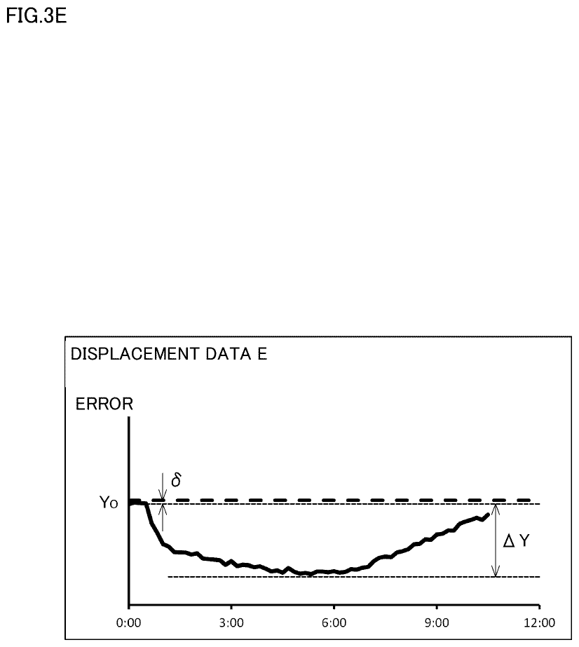

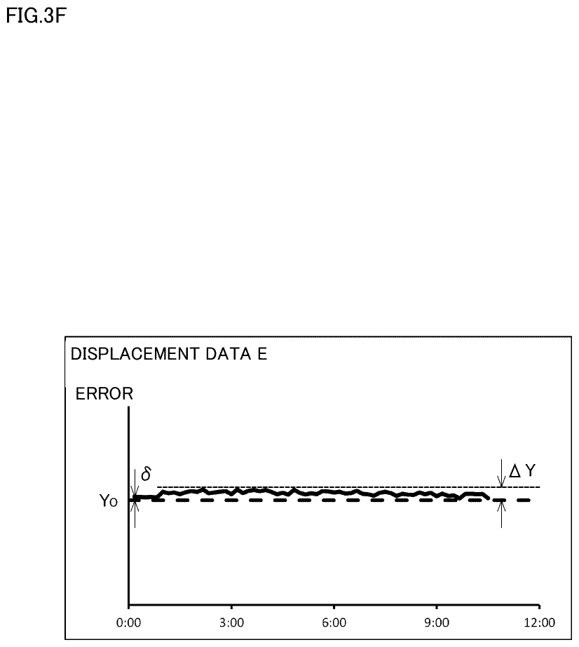

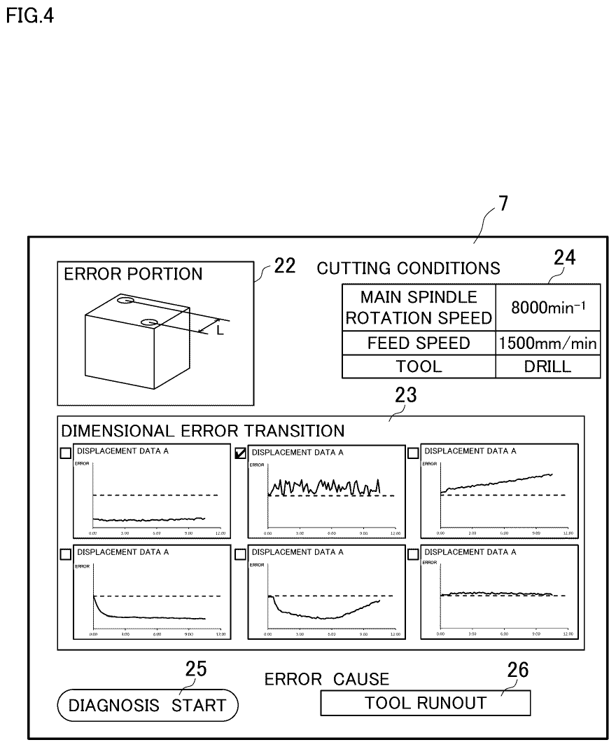

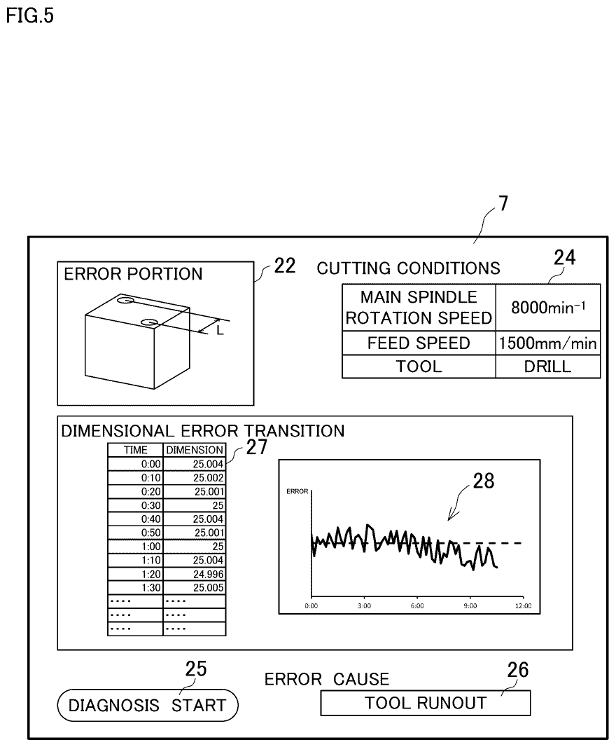

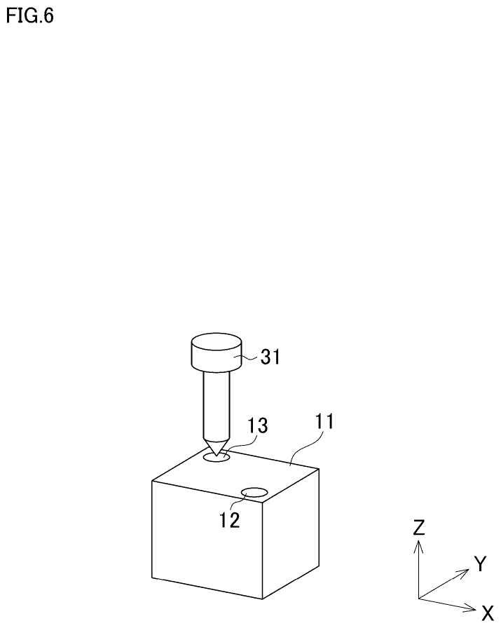

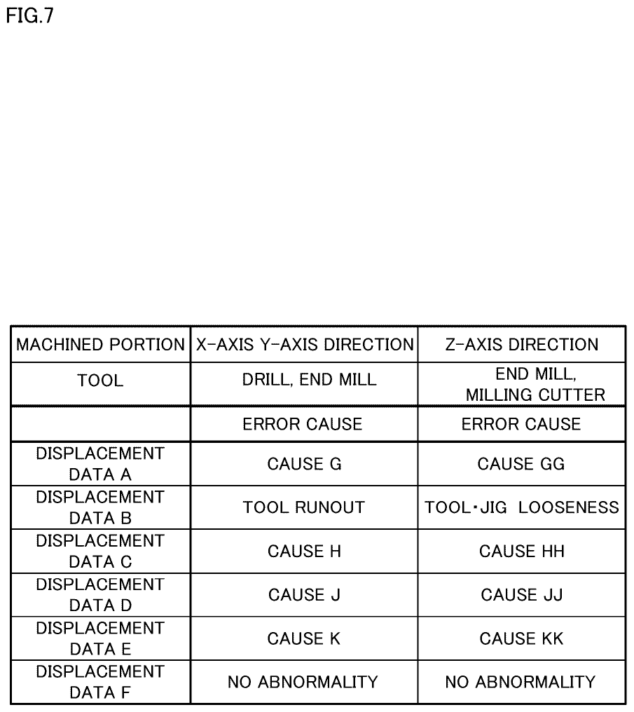

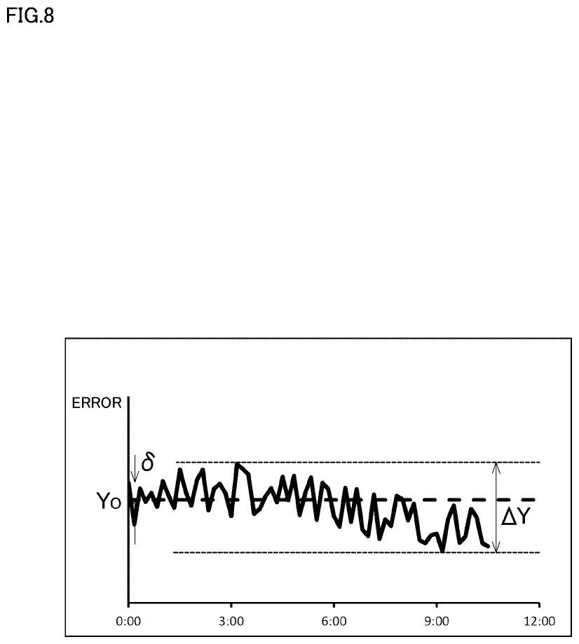

FIG. 1 is a block diagram illustrating a configuration of a diagnostic device 1. FIG. 2 is an explanatory view illustrating a shape diagram of a workpiece 11. FIG. 3 includes FIGS. 3A to 3F, and each of them is an explanatory view illustrating a temporal transition of a plurality of types of machining errors recorded in an error transition recording unit 2. FIG. 4 is an explanatory view illustrating an aspect of display in a display portion 7 of the diagnostic device 1. FIG. 5 is an explanatory view illustrating a modification example of the aspect of display in the display portion 7. FIG. 6 is an explanatory view illustrating a machining method of the workpiece 11. FIG. 7 is a table in which causes of machining errors are associated with machined portions, a type of tool, and displacement data. FIG. 8 is an explanatory view illustrating the temporal transition of the machining errors obtained in actual machining.

First, a workpiece in the embodiment is set to be a workpiece 11 illustrated in FIG. 2. Further, the machining error in the embodiment is an error from a target value Yo when a distance L between holes 12 and 13 in a Y-axis direction is the target value Yo for the holes 12 and 13 drilled on an upper surface of the workpiece 11. In FIG. 2, an X-axis direction is a right-left direction, a Y-axis direction is a front-rear direction, and a Z-axis direction is an up-down direction.

The holes 12 and 13 are machined as follows. First, a drill 31 installed in an NC device 8 is moved and positioned to the X-axis and Y-axis coordinates corresponding the hole 12. Then, the drill 31 is sent in the Z-axis direction to cut the hole 12. Next, after the drill 31 is moved to the X-axis and Y-axis coordinates corresponding the hole 13 and is positioned, it is sent in the Z-axis direction to cut the hole 13. Subsequently, when the machining of the holes 12 and 13 for one workpiece 11 is completed, a new workpiece 11 is replaced and similar machining is repeated.

When the machining of forming the holes 12 and 13 in the workpiece 11 as described above is repeatedly continued, the machining error naturally occurs each time the machining is performed. Then, displacement data, which is a temporal transition of the machining errors caused by repeating such machining, becomes graphs such as those illustrated in FIGS. 3A to 3F. The dashed line at the center of each graph indicates the target value Yo of the distance L. 8 in each graph indicates the machining error from the target value Yo in the first machined workpiece 11 (hereinafter referred to as an initial product). Furthermore, ΔY in each graph indicates a displacement width of the machining error that occurred from the initial product to a finally machined workpiece 11 (hereinafter referred to as a final product), namely, a difference between a smallest machining error and a largest machining error. Information based on graphs illustrated in FIGS. 3A to 3F (hereinafter referred to as displacement data A to F) are error transition information in this description.

Here, features of the temporal transition of the machining errors of the workpiece 11 will be explained.

The displacement data, which is the temporal transition of the machining errors, has various forms as indicated in FIGS. 3A to 3F. Displacement data A has a form in which the machining error δ of the initial product is large and the displacement width ΔY is small. Displacement data B, C, D, and E have a form in which the machining error δ of the initial product is small, but the displacement width ΔY is large. Furthermore, displacement data F has a form in which the machining error δ of the initial product is small and the displacement width ΔY is also small, namely, a form in which the machining errors are overall small.

The displacement data B, C, D, and E can be categorized based on features related to the machining error at each time and the temporal transition of the displacement width ΔY. The displacement data B has a form in which the machining error at each time changes irregularly in a short period of time. The displacement data C has a form in which the displacement width ΔY changes caused by the temporal transition, and in this case increases. The displacement data D has a form in which after the displacement width ΔY changes greatly at the beginning of the machining, the machining error at each time is stabilized in a state after the change, and as a result, the displacement width ΔY is also stabilized. The displacement data E has a form in which, although not changing as short as the displacement data B, the machining error at each time continues to change from the machining start to the machining end without being stabilized.

Furthermore, a method for selecting the similar displacement data from the displacement data obtained in the actual machining will be explained.

When the displacement data indicated in FIG. 8 is obtained as a result of repeatedly continuing the above-described machining of disposing the holes 12 and 13 in the workpiece 11, the displacement data B is selected as the displacement data that exhibits the closest feature among the displacement data A to F. That is, the displacement data B can be selected as it has a form in which, although a machining error δ of the initial product is small, a displacement width ΔY from the initial product to the final product is large, and further, the machining error at each time changes irregularly in a short period of time caused by the temporal transition.

To explain it in more detail, displacement data is selected by a categorize of error transition based on feature quantities described below. In this description, the following items are used as feature quantities. These are the machining error δ of the initial product (initial product machining error Δa), an absolute value Δb of the displacement width ΔY, a maximum value Δc of a difference between the machining error in the previous machining and the machining error in the current machining, an error Δd with a linear approximation value, and an error Δe with a first-order lag equation approximation value. Then, when the the initial product machining error Δa exceeds a predetermined determination value J1 (first error transition), the displacement data A is selected. When the absolute value Δb of the displacement width ΔY exceeds a predetermined determination value J2 and the maximum value Δc of the difference between the previous and current machining errors also exceeds a predetermined determination value J3 (third error transition), the displacement data B is selected. When the absolute value Δb of the displacement width ΔY exceeds the determination value J2, but the error Δd with the linear approximation value is smaller than a predetermined determination value J4 (fourth error transition), the displacement data C is selected. When the absolute value Δb of the displacement width ΔY exceeds the determination value J2, but the error Δe with the first-order lag equation approximation value is smaller than a predetermined determination value J5 (fifth error transition), displacement data D is selected. When the absolute value Δb of the displacement width ΔY exceeds the determination value J2, but the maximum value Δc of the difference between the previous and current machining errors is smaller than the determination value J3, and the error Δd with the linear approximation value and the error Δe with the first-order lag equation approximation value are respectively larger than predetermined determination values J4 and J5 (sixth error transition), the displacement data E is selected. When both the initial product machining error Δa and the absolute value Δb of the displacement width ΔY are respectively smaller than their respective determination values J1 and J2 (second error transition), displacement data F is selected. for example, it is assumed that the absolute value of the displacement width ΔY exceeds the determination value and the maximum value of the difference between the previous and current machining errors also exceeds the determination value when the displacement data indicated in FIG. 8 is obtained. In this case, since displacement data indicated in FIG. 8 is categorized into the third error transition as described above, the displacement data B is selected. In the embodiment, the operator selects similar displacement data as described later. However, as described as a modification example, it is also possible to configure the diagnostic device such that it automatically selects a similar modification example.

Based on the above, cause diagnosis of the machining errors by the diagnostic device 1 will be explained.

The diagnostic device 1 includes the error transition recording unit 2 in which the displacement data A to F are recorded and the display portion 7 that displays various information including the displacement data A to F. The diagnostic device 1 is provided with an error transition input unit 3, a machined portion input unit 4, and a cutting condition input unit 5. The error transition input unit 3 is used for selecting the displacement data displayed on the display portion 7. The machined portion input unit 4 is used for inputting a machined portion together with the shape diagram of the workpiece 11. The cutting condition input unit 5 is used for inputting cutting conditions such as a main spindle rotation speed, a main spindle feed speed during machining, and the type of tool used for machining. Furthermore, the diagnostic device 1 is provided with an error cause recording unit 9 in which the causes of the machining errors are recorded. In the error cause recording unit 9, as indicated in a table illustrated in FIG. 7, a plurality of types of causes preliminarily assumed as the causes of the machining errors are each recorded in association with the machined portion, the type of tool, and displacement data. In addition, the diagnostic device 1 is provided with a cause diagnosis unit 6 that diagnoses the causes of the machining error from the information input into the error transition input unit 3, the machined portion input unit 4, and the cutting condition input unit 5 and the information recorded in the error cause recording unit 9. The diagnostic device 1 includes a central processing unit (CPU) and a memory connected to the CPU and allows the operations of the respective units.

In the display portion 7, various information including the displacement data is displayed in an aspect illustrated in FIG. 4. Namely, the display portion 7 is provided with an error-portion-display-portion 22, an error-transition-display-portion 23, and a cutting-condition-display-portion 24. The error-portion-display-portion 22 displays the shape diagram and the machined portion of the workpiece 11 and also displays an error portion where the machining error occurs. The error-transition-display-portion 23 displays the displacement data A to F recorded in the error transition recording unit 2. The cutting-condition-display-portion 24 displays, for example, the cutting conditions including the type of tool. The display portion 7 is provided with a diagnosis-start-button 25 and an error-cause-display-portion 26. The diagnosis-start-button 25 is used for starting the cause diagnosis of the machining errors after inputting the machined portion and the cutting conditions and selecting the displacement data. The error-cause-display-portion 26 displays diagnostic results by the cause diagnosis unit 6, namely the causes of the machining errors identified by the cause diagnosis unit 6.

Then, a specific example of the cause diagnosis of the machining errors by the above-described diagnostic device 1 when the displacement data illustrated in FIG. 8 is obtained in the current machining will be explained as follows. First, an operator inputs the shape diagram of the workpiece 11 by the machined portion input unit 4 and selects the holes 12 and 13. Subsequently, the error-portion-display-portion 22 displays a distance in the X-axis direction and a distance in the Y-axis direction as a distance between the holes 12 and 13 where the machining error occurs. Then, the operator inputs through the machined portion input unit 4 that the machining error for which the cause diagnosis is to be performed this time is a machining error related to the distance L in the Y-axis direction. The diagnostic device 1 may be connected to the NC device 8, and the input of the shape diagram of the workpiece 11 may be selected from the shape diagrams of the workpieces preliminarily stored in the NC device 8.

Next, by the error transition input unit 3, the operator selects the displacement data B the features of which are closest to the displacement data illustrated in FIG. 8 from among the displacement data A to F displayed on the error-transition-display-portion 23. Furthermore, by the cutting condition input unit 5, the operator inputs the main spindle rotation speed and the main spindle feed speed during machining, and the type of tool used for the machining. The cutting condition input at this time are displayed on the cutting-condition-display-portion 24. With the diagnostic device 1 being kept connected to the NC device 8, the input of the cutting conditions may also be selected from machining program information preliminarily stored in the NC device 8.

With completion of the above-described input, the operator operates the diagnosis-start-button 25 in the display portion 7. Then, the cause diagnosis unit 6 refers to the table illustrated in FIG. 7 and identifies that the error cause is “a tool runout” from the information input by the machined portion input unit 4, the displacement data selected by the error transition input unit 3, and the information input by the cutting condition input unit 5. Subsequently, the cause diagnosis unit 6 displays “the tool runout” on the error-cause-display-portion 26 as the result of the error diagnosis. Therefore, by referring to the error-cause-display-portion 26, the operator can determine that the cause of the machining error is “the tool runout.”

According to the diagnostic device 1 having the above-described configuration, the error transition recording unit 2, the error transition input unit 3, the error cause recording unit 9, the cause diagnosis unit 6, and the display portion 7 are disposed. The error transition recording unit 2 is configured such that a plurality of types of displacement data A to F are recorded. The error transition input unit 3 selects one piece of displacement data from the plurality of types of displacement data A to F. The error cause recording unit 9 is configured such that a plurality of types of causes are each recorded in association with the displacement data A to F. The cause diagnosis unit 6 refers to the error cause recording unit 9 and identifies the cause based on the displacement data selected by the error transition input unit 3. The display portion 7 displays the cause identified by the cause diagnosis unit 6. Accordingly, by simply selecting the displacement data similar to the current machining circumstances, the operator can grasp the cause of the machining error. Therefore, even a less experienced operator can easily and reliably diagnose the causes of the machining errors. Since there is no need to collect the machine data that is likely to become factors of the machining errors during machining, it is possible to achieve reduced cost of the diagnostic device 1.

The diagnostic device 1 is provided with the machined portion input unit 4 and the cutting condition input unit 5. The machined portion input unit 4 is used for inputting the machined portion information that is information related to identification of the machining error, for example, the shape diagram of the workpiece 11 and the machined portion. The cutting condition input unit 5 is used for inputting the cutting condition information that is information related to the machining to the workpiece 11, for example, the main spindle rotation speed, the main spindle feed speed during the machining and the type of tool used for the machining. Furthermore, the causes of the machining errors are also associated with the machined portion and the type of tool. The cause diagnosis unit 6 is configured to refer to the error cause recording unit 9 and identify the causes based on the information input by the machined portion input unit 4, the displacement data selected by the error transition input unit 3, and the information input by the cutting condition input unit 5. Therefore, it is possible to diagnose the causes of the machining errors more accurately.

Furthermore, by connection to the NC device 8, the input of the shape diagram of the workpiece 11 may be selected from the shape diagrams of the workpieces preliminarily stored in the NC device 8. Furthermore, the input of the cutting conditions may also be selected from the machining program information preliminarily stored in the NC device 8. Thus, by connection to the NC device 8, it is possible to diagnose the causes of the machining errors more easily.

The diagnostic device according to the disclosure is not limited to the aspects of the above-described embodiment. Not only the overall configuration of the diagnostic device but also the configuration related to the cause diagnosis of the machining errors can be modified appropriately as necessary without departing from the gist of the disclosure.

For example, in the above-described embodiment, the display portion 7 is provided with the error-transition-display-portion 23 that displays the displacement data A to F and is configured such that the operator can select the similar displacement data. However, instead of such error-transition-display-portion 23, a dimensional error transition display portion 27 and an actually-measured-value-data-display-portion 28 as illustrated in FIG. 5 may be disposed. It is possible to configure the actually-measured-value-data-display-portion 28 to display the displacement data of the machining error that has occurred this time by the operator inputting the dimensional error. Furthermore, it is possible to configure the diagnostic device 1 to automatically select similar displacement data and in addition, the cause of the machining error to be displayed on the error cause display portion 26.

In a modification example illustrated in FIG. 5, after inputting with the machined portion input unit 4, an operator measures the dimensions of the actually machined workpiece 11 with the error transition input unit 3 and inputs machining time and the dimensions or the machining errors. The input values are displayed on the dimensional-error-transition-display-portion 27. The displacement data of the machining error corresponding to the input values, namely, the displacement data of the machining error that has occurred this time is displayed on the actually-measured-value-data-display-portion 28. Subsequently, the diagnosis-start-button 25 is operated by the operator. Then, based on the input values, the error transition input unit 3 calculates at least one of the machining error δ of the initial product, the absolute value of the displacement width ΔY, the maximum value of the difference between the machining error in the previous machining and the machining error in the current machining, the error with the linear approximation value, and the error with the first-order lag equation approximation value as a feature quantity. Based on the calculated feature quantities, by the method described as the displacement data selection method in the above-described embodiment, namely, by the displacement data selection method based on the categorizing the calculated feature quantities into first to sixth error transitions, similar displacement data is selected from among the displacement data A to F recorded in the error cause recording unit 9. Then, the cause diagnosis unit 6 identifies the error cause from the selected displacement data and the information input by the machined portion input unit 4 and the cutting condition input unit 5 and displays the identified error cause on the error-cause-display-portion 26.

Also, in the diagnostic device of the modification example having the above-described configuration, similarly to the diagnostic device 1 of the above-described embodiment, there is no need to collect the machine data that is likely to become the factors of the machining errors during machining. Thus, it is possible to achieve the reduced cost of the diagnostic device. In addition, the error transition input unit 3 allows input of the actually measured value of the temporal transition of the machining errors. Based on the input actually measured value of the temporal transition, the error transition input unit 3 calculates the machining error δ of the initial product, the absolute value of the displacement width ΔY, the maximum value of the difference between the machining error in the previous machining and the machining error in the current machining, the error with the linear approximation value, and the error with the first-order lag equation approximation value, which are the feature quantities related to the displacement data selection. Then, since the error transition input unit 3 automatically selects the displacement data based on the calculated feature quantities, even a less experienced operator can easily and reliably diagnose the causes of the machining errors.

In the above-described embodiment and the modification example, one displacement data is selected. However, as another modified aspect, it may be configured, for example, to select a plurality of pieces of displacement data and displays the causes of a plurality of types of machining errors corresponding to each piece of displacement data on the display portion. In the error cause recording unit, it is possible to change how the temporal transition of the machining error and the cause of the machining error are specifically associated. There is no problem even when the causes of the plurality of types of machining errors are associated with one piece of displacement data.

Furthermore, while, in the above-described embodiment and the modification example, the machined portion input unit and the cutting condition input unit are disposed, only any one of them may be disposed, or it is also possible to dispose neither of them. Namely, by selecting the temporal transition of the machining errors, it is also possible to configure the causes of the plurality of types of machining errors to be displayed in association with each piece of machined portion information or in association with each piece of cutting condition information. Needless to say, the design of how the causes of machining errors, the machined portions, the cutting conditions, and the like are specifically displayed on the display portion, as well as the display aspect and layout can be changed.

In addition, the temporal transition of the machining errors caused by repeating the machining in the disclosure is not limited to one in which the machining errors caused by each machining operation are associated with machining time. The temporal transition includes one in which the machining errors caused by each machining operation are associated with a count of times of machining and one in which the machining errors caused by each machining operation are associated with a count of pieces of machining. Furthermore, in addition to errors occurring in the workpiece in the above-described embodiment, the machining errors in the disclosure includes, for example, an error in a tool length offset measured by a tool sensor and an error in a machining origin point of the workpiece measured by a probe.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A diagnostic device for diagnosing a cause of a machining error that occurs at each machining operation on a plurality of workpieces having a same shape, the diagnostic device comprising:
an error transition recording unit in which a plurality of types of error transition information with different temporal transitions of the machining error caused by repeating the machining are recorded;
an error transition input unit that selects at least one of pieces of error transition information from the plurality of types of error transition information;
an error cause recording unit in which a plurality of types of the causes are each recorded in association with the error transition information;
a cause diagnosis unit that refers to the error cause recording unit and identifies the causes based on the error transition information selected by the error transition input unit; and
a display portion that displays the causes identified by the cause diagnosis unit.

2. The diagnostic device according to claim 1, further comprising:
a machined portion input unit used for inputting machined portion information that is information related to identifying the machining error in the workpiece; and
a cutting condition input unit used for inputting cutting condition information that is information related to machining to the workpiece, wherein
the cause is also associated with the machined portion information and the cutting condition information, and
the cause diagnosis unit refers to the error cause recording unit and identifies the cause based on the error transition information selected by the error transition input unit, the machined portion information input by the machined portion input unit, and the cutting condition information input by the cutting condition input unit.

3. The diagnostic device according to claim 2, wherein
the diagnostic device is connected to an NC device, and
at least any one piece of the machined portion information and the cutting condition information can be selected and input from data recorded in the NC device.

4. The diagnostic device according to claim 1, wherein
an actually measured value of the temporal transition of the machining error is allowed to be input by the error transition input unit, and
based on the input actually measured value of the temporal transition, the error transition input unit calculates at least one of the initial product machining error Δa which is the machining error from a target value in a first machined workpiece, an absolute value Δb of a displacement width of the machining error that has occurred between the first machined workpiece and a finally machined workpiece, a maximum value Δc of a difference between the machining error in previous machining and the machining error in current machining, an error Δd with a linear approximation value, and an error Δe with a first-order lag equation approximation value, as feature quantities related to selection of the error transition information, and selects the error transition information based on the calculated feature quantities.

5. The diagnostic device according to claim 4, wherein
the error transition information is categorized into at least one of a first to sixth error transition,
where the first error transition is a case in which the initial product machining error Δa exceeds a predetermined determination value J1,
the second error transition is a case in which the initial product machining error Δa is smaller than the determination value J1 and the absolute value Δb of the displacement width ΔY is smaller than a determination value J2,
the third error transition is a case in which the absolute value Δb of the displacement width ΔY exceeds a predetermined determination value J2 and the maximum value Δc of the difference between the previous and current machining errors also exceeds a predetermined determination value J3,
the fourth error transition is a case in which the absolute value Δb of the displacement width ΔY exceeds the determination value J2, but the error Δd with the linear approximation value is smaller than a predetermined determination value J4,
the fifth error transition is a case in which the absolute value Δb of the displacement width ΔY exceeds the determination value J2, but the error Δe with the first-order lag equation approximation value is smaller than a predetermined determination value J5,
the sixth error transition is a case in which the absolute value Δb of the displacement width ΔY exceeds the determination value J2, the error Δd with the linear approximation value is larger than predetermined determination value J4 and the error Δe with the first-order lag equation approximation value is larger than predetermined determination value J5, and
the cause diagnosis unit identifies the causes based on the error transition information categorized into the first to sixth error transition or a combination thereof.
